(19) United States
(12) Patent Application Publication
(10) Pub. No.: US 2003/0104184 A1
(43) Pub. Date: Jun. 5, 2003

(54) Multiple wiring board

(75) Inventors: Taro Hirai, Ohtsu-Shi (JP); Shigekazu Hino, Ohtsu-Shi (JP); Gorou Ikegami, Ohtsu-Shi (JP); Yukitaka Tokumoto, Ohtsu-Shi (JP)

Correspondence Address: YOUNG & THOMPSON, 745 SOUTH 23RD STREET 2ND FLOOR, ARLINGTON, VA, 22202

(73) Assignee: NEC ELECTRONICS CORPORATION, Kanagawa (JP)

(21) Appl. No.: 10/303,716

(22) Filed: Nov. 26, 2002

(30) Foreign Application Priority Data
Nov. 30, 2001 (JP) 2001-365581

(51) Int. Cl. B32B 3/00

(52) U.S. Cl. 428/209

(57) ABSTRACT

A multiple mother board holding electronic components has frame-shaped reinforcing conductive films surrounding peripheries on both surfaces of the mother board. In the conductive films, plural minute openings are formed such that positions of the openings on both surfaces are shifted from each other.

### BACKGROUND OF THE INVENTION

1. Field of the Invention

The present invention relates to a multiple wiring board for electronic components, and more particularly, to a multiple wiring board having a reinforced structure.

2. Description of the Prior Art

Many of electronic components used in information electronic devices such as a cellular phone are mass-produced using a lead frame, a multiple wiring board and the like.

Japanese Published Unexamined Patent Application No. Hei 10-313082 discloses an example of electronic component using a lead frame.

As shown in FIG. 2, a multiple wiring board is formed by mounting a large number of groups of mount pad conductive pattern 3 and terminal pad conductive patterns 4 and 5, on a single insulating substrate 2A.

As shown in FIG. 1, an electronic device 10 such as a semiconductor chip is mounted on the conductive pattern 3 corresponding to an island, and an electrode of the electronic device 10 is electrically connected to the terminal pad conductive patterns 4 and 5 via bonding wires 11 and 12. As shown in FIG. 3, external terminals 6 to 8 are formed on the rear surface of wiring board 1, and as shown in FIG. 1, electrical connection is made between the external terminal 6 and the conductive pattern 3 via a contact hole 36, further, electrical connection is made between the external terminals 7 and 8 to the conductive patterns 4 and 5 via a contact hole 47. The side where the electronic device 10 is mounted is covered with resin 13. Respective electronic components are cut along dotted lines in FIG. 2 from this mother board.

For example, in a case where a 1.0-mm long 0.8-mm wide and 0.6-mm thick electronic component 14 is fabricated by using a 150-mm long 30-mm wide and 0.2-mm thick wiring board 9, 16 columns×32 rows (512) conductive pattern groups can be arrayed there.

To realize such small electronic components, it is important to reduce the thickness of the wiring board 9. However, if the wiring board is thin, the strength of the board is reduced, and movement upon fabrication and/or positioning cannot be performed without difficulty. Especially, if such thin board is heated in a fabrication process, the resin insulating substrate 2A is softened, and accuracy of positioning is degraded.

As a thin resin substrate such as a polyimide film is used as the above-described multiple wiring board, there is a possibility that the substrate is deformed upon mounting of electronic device or flow soldering.

As means for preventing deformation of wiring board such as a polyimide film, Japanese Published Unexamined Patent Application No. Hei 10-65320 discloses attaching a reinforcing plate having vent holes to the entire rear surface of substrate with adhesive. However, as a process of stripping the plate is required in addition to the process of attaching the reinforcing plate to the substrate, the number of fabrication process steps increases. Further, due consideration must be given to stripping of the reinforcing plate so as to avoid influence on the electronic component.

### SUMMARY OF THE INVENTION

The present invention has its object to provide a wiring mother board which can be prevented from being deformed even if heated to a high temperature in an electronic component fabrication process.

A multiple wiring board according to the present invention is characterized in that, in a wiring mother board on which plural wiring patterns are provided, a reinforcing conductive film having openings is formed on both surfaces of peripheral portion of the wiring mother board. In the reinforcing conductive film, the positions of openings on front and rear surfaces are shifted from each other. If the width of the reinforcing conductive film is 5 mm, it is preferable that the interval between adjacent openings of the first conductive film is set to 0.1 to 2 mm. Therefore, the interval between adjacent openings of the reinforcing conductive film is set to 0.1 to 2 mm.

It is preferable that the openings are formed in an approximate grid pattern. Especially, it is preferable that the direction of array of openings is slanted at 30° to 60° to the peripheral portion of the insulating substrate.

The shape of opening is not particularly limited, however, it may be a polygonal shape including a round shape.

In the multiple wiring board of the present invention, one of the first and second conductive films is formed such that the opening group on one surface overlaps with intersections between a opening group and another opening group on the other surface.

### BRIEF DESCRIPTION OF THE DRAWINGS

FIG. 1 is a cross-sectional view showing an example of electronic component cut from a multiple wiring board;

FIG. 2 is a top plan view showing an example of the conventional multiple wiring board used in fabrication of the electronic component in FIG. 1;

FIG. 3 is a bottom view of the multiple wiring board in FIG. 2;

FIG. 4 is a top plan view of a multiple wiring board as a first example compared to the present invention;

FIG. 5 is a principle-part perspective cross-sectional view of a multiple wiring board as a second example compared to the present invention;

FIG. 6A is a top plan view of a multiple wiring board according to an embodiment of the present invention;

FIG. 6B is a bottom view of the multiple wiring board in FIG. 6A;

FIG. 6C is a cross-sectional view of the multiple wiring board along a line I-I in FIG. 6A;

FIG. 7 is a principle-part perspective cross-sectional view of the multiple wiring board in FIG. 6A;

FIG. 8 is a principle-part expanded cross-sectional view showing water vapor moving paths in the multiple wiring board according to the embodiment;

FIG. 9 is a principle-part plan view of the multiple wiring board, according to the embodiment in FIG. 6;

FIG. 10 is a principle-part expanded plan view of the multiple wiring board according to another embodiment of the present invention;

FIG. 11 is a cross-sectional view of the multiple wiring board along a line X-X in FIG. 10;

FIG. 12 is a principle-part plan view of the multiple wiring board according to a modification of openings;

FIG. 13 is a principle-part plan view of the multiple wiring board according to another modification of the openings; and

FIG. 14 is a principle-part plan view of the multiple wiring board according to another modification of the openings.

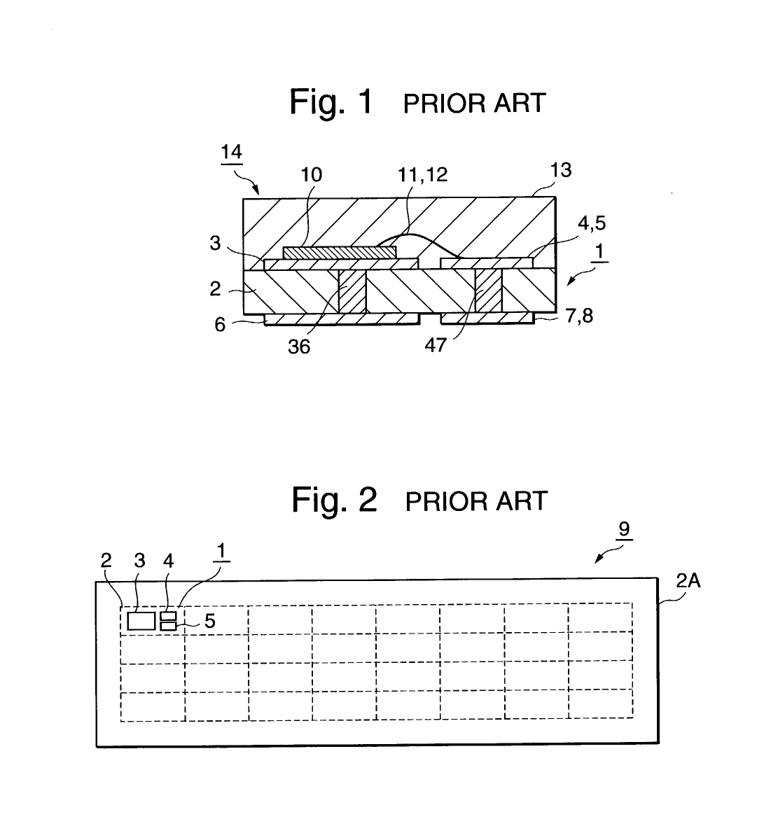

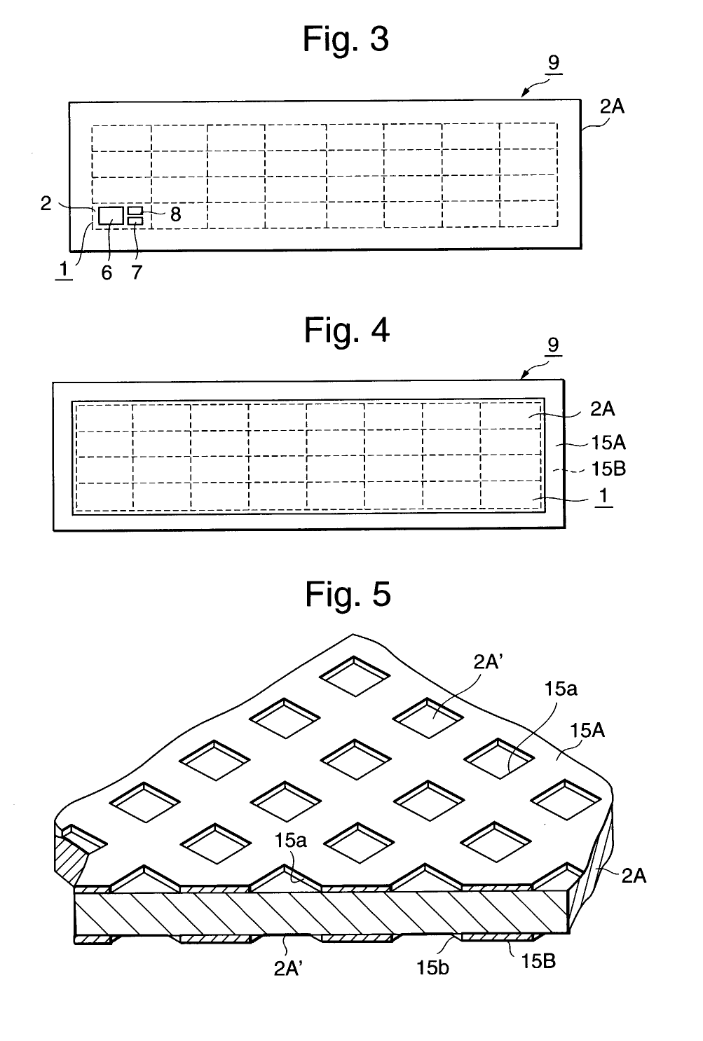

### DETAILED DESCRIPTION OF THE PREFERRED EMBODIMENTS

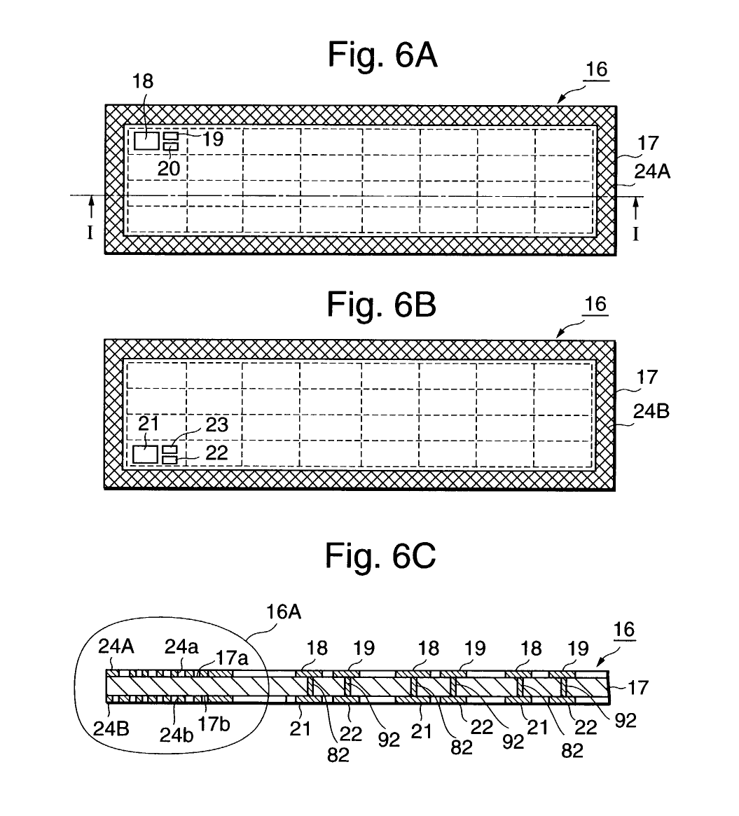

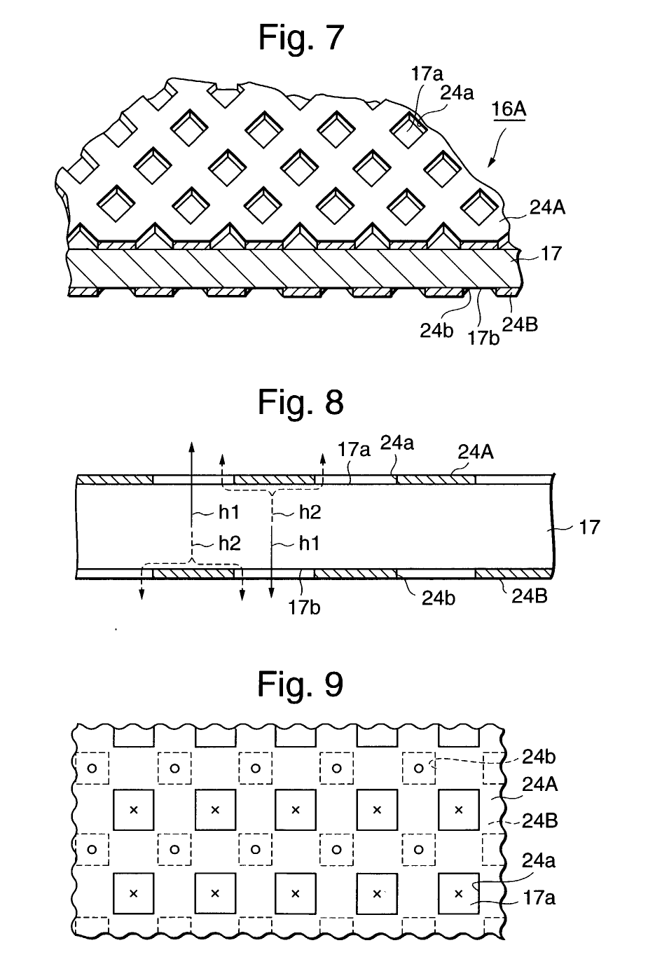

A preferred embodiment of the present invention will now be described in detail in accordance with FIGS. 6A to 6C and FIG. 7. A mother board 16 of the present invention has frame-shaped reinforcing areas 24A and 24B, having a large number of openings 24a and 24b as vent holes, on the periphery of its both surfaces. The inner area of the frame-shaped reinforcing area is divided into small areas surrounded by a dotted line in the figure. As shown in FIG. 6A, a first conductive pattern 18 as an island and a conductive pattern group including a set of second and third conductive patterns 19 and 20, are formed in each small area. As shown in FIG. 6B, on the rear surface side of the mother board, conductive patterns 21 to 23 as external electrodes corresponding to the above conductive patterns are formed in each small area.

As shown in FIG. 6C, electrical connection is made between the conductive patterns formed on the both surfaces via contact holes 82 and 92. It is preferable that the reinforcing conductive thin films 24A and 24B are made at the same time of formation of the above conductive patterns for electronic components using the same material.

The feature of the reinforcing conductive thin films 24A and 24B of the present invention is that, as shown in FIGS. 6C and 7, the positions of the openings are shifted such that an area where the openings overlap with each other via an insulating substrate 17 is reduced.

When the wiring board 16 is heated in fabrication processes such as a mounting process and a wire bonding process, water vapor h1 and h2, vaporized and volume-expanded in the insulating substrate 17, move to the both surface sides as shown in FIG. 8. The water vapor h1 moving toward exposed parts including the openings 24a and 24b of the conductive thin film 24 is released into the atmosphere from the insulating substrate 17. As the pressure inside the resin is reduced by the emission of the water vapor h1, the insulating substrate 17 except the conductive thin films 24 can be prevented from being deformed.

On the other hand, the water vapor h2 arrived at adhesion interfaces of the conductive thin films 24 from the inside is blocked by the conductive thin films 24, and its pressure is increased between the conductive thin films 24 and the insulating substrate 17. The pressure-raised water vapor h2 interferes with the direction of the subsequent water vapor h2, then the subsequent water vapor h2 moves toward the nearest openings 24a and 24b, and released to the outside.

The increase in pressure at the adhesion interfaces is suppressed, and the water vapor staying in these portions is also released to the outside from the nearest openings 24a and 24b. As the pressure of water vapor in the adhesion interface positions between the insulating substrate 17 and the conductive thin films 24 is limited, expansion of the conductive thin films 24 and deformation of the insulating substrate 17 can be prevented.

In the conductive thin films 24A and 24B shown in FIGS. 7 and 8, the ratio between the diameter of the openings 24a and 24b and the interval between the openings 24a and 24b is 1:1. In this case, the farthest positions from the peripheries of the respective openings 24a and 24b on the conductive thin films 24A and 24B are intersections of lines extended from diagonal lines of the openings (“o” and “X” positions in FIG. 9). When the wiring board 16 is heated, the water vapor pressure is most increased in these positions.

On the other hand, as the centers of the openings 24a and 24b correspond to these “o” and “X” positions, the water vapor is emitted from the opening 24a or 24b of the surface.

An intermediate position in the array direction of the openings 24a and that in the array direction of the openings 24b overlap with each other on the both surfaces of the insulating substrate 17. Accordingly, the both surfaces of the insulating substrate 17 are covered with the conductive thin films 24A and 24B in these areas. The water vapor occurred in the insulating substrate 17 are blocked by these conductive thin films 24A and 24B, thereby its pressure is increased, however, it is emitted from the near openings 24a and 24b. Thus the increase in the water vapor pressure is suppressed.

In this manner, in the case where the ratio between the diameter of the openings 24a and 24b and the interval between the openings 24a and 24b is 1:1, although the distribution of water vapor in the insulating substrate 17 varies in accordance with positions in the conductive thin films 24A and 24B, the increase in the water vapor pressure is suppressed, and expansion of the conductive thin films and deformation of the insulating substrate can be prevented.

In the above embodiment, the conductive pattern 21 on the rear surface, corresponding to the conductive pattern 18 on the front surface, has the same size of that of the pattern 18, however, it may be divided into small patterns in consideration of mountability by reflow soldering. Further, although not illustrated, in a case where the conductive patterns 18 to 20 and 21 to 23 are formed by plating, the adjacent conductive patterns are electrically connected.

Next, the present invention will be described in comparison with a case where openings are not formed in the reinforcing conductive thin films as shown in FIG. 4.

The reinforcing conductive thin films 15A and 15B have a thermal expansion coefficient very different from that of the insulating substrate 2A, however, they produce a reinforcement effect in that they are formed on both surfaces of insulating substrate 2A, thereby bimetal effect can be cancelled and distortion of the wiring board 2A can be prevented.

However, as shown in FIG. 4, the material of the insulating substrate 2A, polyimide resin or epoxy resin, absorbs water by long-hour exposure in ambient air even though it has been preserved in dry status. The moisture is vaporized and emitted from the resin surface in a heating process. However, in the wide conductive thin films 15A and 15B, as the emission of volume-expanded moisture is prevented, bubbles occur between the insulating substrate 2A and the conductive thin films 15A and 15B. In some cases, the conductive thin films 15 are deformed by water vapor pressure, and the wiring board 2A is wrinkled or deformed.

If the wiring board 9 is deformed, positioning accuracy is degraded. As the wiring board 9 is partially floated, mounting and wire bonding cannot be easily performed on fine electronic devices. The present invention can prevent such inconvenience.

Further, studied is a case where openings (vent holes) 15a and 15b of the reinforcing conductive thin films 15A and 15B are in the same positions on the both front and rear surfaces as shown in FIG. 5. In this case, expansion of the conductive thin films 15 and deformation of the wiring board 9 are mitigated but not completely prevented even by changing the shape or diameter of the openings 15a and 15b or changing array interval of the openings. Accordingly, the advantages of the present invention have been verified.

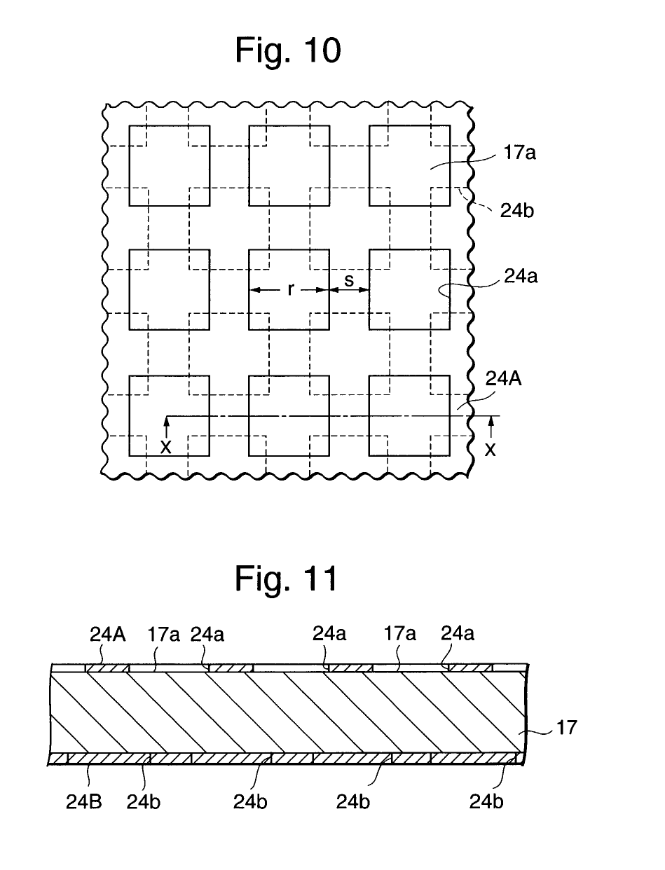

Next, the wiring board according to another embodiment of the present invention will be described with reference to FIGS. 10 and 11. Note that constituent elements corresponding to those of the wiring board of the previous embodiment have the same reference numerals, and explanations of these elements will be omitted.

In the wiring board of this embodiment, the difference is that the ratio between the diameter r of the openings 24a and 24b and the interval s between the openings (r/s) is 2:1.

In this arrangement, the area where the conductive thin films 24A and 24B on the front and rear surfaces completely overlap with each other is reduced with respect to the area of the opening 24a. As a part of the opening 24a on one surface of the insulating substrate 17 overlaps with the opening 24b on the other surface, the variation of distribution of water vapor in the insulating substrate 17 can be reduced. Accordingly, even if a thick insulating substrate 17 is quickly heated, the moisture included in the insulating substrate can be quickly released, and expansion of the conductive thin film 24 and deformation of the insulating substrate 17 can be prevented.

As described above, according to the present invention, the expansion of the reinforcing conductive thin film 24 and deformation of the substrate change in accordance with various conditions such as the thickness of the insulating substrate 17, the amount of moisture absorbed in the resin and the slope of heating temperature. Further, the width of the conductive thin film 24 is closely related to an effective area of the wiring board 16. As the width of the conductive thin film 24 is increased, the reinforcement effect is increased, on the other hand, the effective area is reduced. Further, the diameter of the openings 24a and 24b is related to the reinforcement effect in the wiring board 16. As the diameter r is increased and the interval s is reduced, the reinforcement effect is reduced. The width of the conductive thin film 24, the diameter of the openings 24a and 24b, and the array interval and the like are set in consideration of above relation.

For example, in a case where a conductive thin film 24, having a laminated structure where an electroless copper-plating layer is formed on a 150-mm long 30-mm wide and 0.025 to 0.2-mm thick substrate of polyimide and a conductive thin film 24 having electrolytic copper-plating layer is formed on the electroless copper-plating layer, is formed on the periphery of the insulating substrate 17 such that the conductive thin film 24 has a width of 5 mm, if the width s of the conductive thin film 24 between adjacent openings 24a, 24a and 24b, 24b is greater than 2 mm, even if the opening diameter is 2 mm or greater, expansion occurs under the conductive thin film 24. If the opening diameter r is greater than 2 mm, the 5 mm width conductive thin film 24 is broken by the openings, thus the reinforcement effect is degraded.

If the array interval s is less than 0.5 mm, water vapor can be sufficiently released even though the diameter r of the openings 24a and 24b is 0.05 mm.

If the array direction of the openings 24a and 24b is parallel or orthogonal to a side wall of the insulating substrate 17, the array direction of the openings corresponds with an expansion/compression direction of the wiring board 16, which reduces the reinforcement effect in the wiring board.

From these findings, the wiring board 16 can be sufficiently reinforced by setting the interval s between the openings 24a and 24b of the conductive thin film 24 to 0.1 to 2 mm so as to prevent breakage of the conductive thin film 24 by the openings, and arraying the openings in grid in a direction diagonal to the side of the insulating substrate 17 at 30° to 60°, more preferably, 45°.

Note that it is preferable that the reinforcing conductive thin film is formed at the same time of formation of the conductive patterns using the same material, however, it may be formed separately using another material.

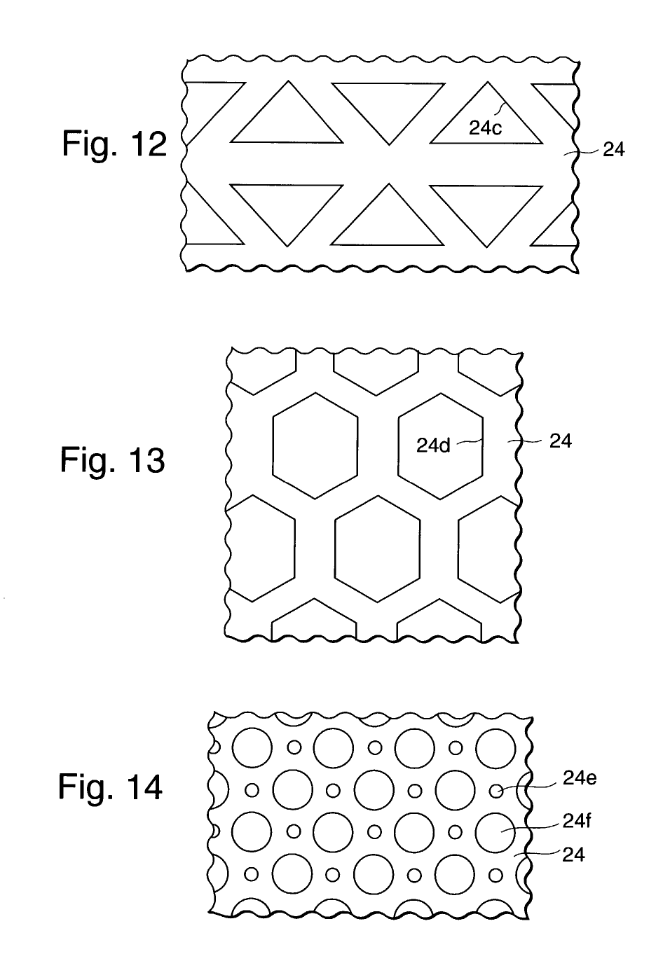

The plane shape of the openings 24a and 24b is not limited to a square or rectangular shape but may be a polygonal shape including a round shape. For example, triangular openings 24c may be arrayed as shown in FIG. 12, or hexagonal openings 24d may be arrayed as shown in FIG. 13. Further, as shown in FIG. 14, round openings 24e and 24f having different diameters are alternately arrayed such that a large-diameter opening is provided on one surface in a position corresponding to a small-diameter opening on the other surface.

As described above, according to the present invention, the problems upon formation of reinforcing conductive thin film on the periphery of both surfaces of insulating substrate, i.e. expansion of conductive thin film and deformation of insulating substrate, which have not been prevented by merely forming openings, can be prevented without degradation of the reinforcement effect in the insulating substrate.

What is claimed is:

1. A multiple wiring board comprising:
a wiring mother board provided with a plurality of wiring patterns;
a first reinforcing conductive film formed along a periphery on a front surface of said wiring mother board, said first reinforcing conductive film having a first opening group of arrayed plural openings; and
a second reinforcing conductive film formed along a periphery on a rear surface of said wiring mother board, said second conductive film having a second opening group of arrayed plural openings such that positions of the openings of said first opening group and positions of the openings of said second opening group are different.

2. The multiple wiring board according to claim 1, wherein a width of adjacent said conductive films between said first and second opening groups is 0.1 to 2 mm.

3. The multiple wiring board according to claim 1, wherein said first and second conductive films are formed in approximate grid.

4. The multiple wiring board according to claim 1, wherein an array direction of the respective openings of said first and second opening groups is slanted at 30° to 60° with respect to an outer periphery of said insulating substrate.

5. The multiple wiring board according to claim 1, wherein the shape of the openings of said first and second opening groups is a polygonal shape including a round shape.

6. The multiple wiring board according to claim 1, wherein the shape of the openings of said first and second opening groups is a triangular shape.

7. The multiple wiring board according to claim 1, wherein the shape of the openings of said first and second opening groups is a hexagonal shape.

8. The multiple wiring board according to claim 1, wherein said first conductive film has a first opening, and said first opening is arrayed in vertical and lateral directions at an interval obtained by adding a first diameter (r1) of said first opening and a first interval (s1) between said first opening and a second opening adjacent to said first opening, as a reference,
and wherein said second conductive film has a third opening, and said third opening is arrayed in the vertical and lateral directions at an interval obtained by adding a second diameter (r2) of said third opening and a second interval (s2) between said third opening and a fourth opening adjacent to said third opening, as a reference,
further wherein said first opening and said third opening overlap with each other.

9. The multiple wiring board according to claim 8, wherein said first diameter (r1) and said second diameter (r2) are equal to each other, and said first interval (s1) and said second interval (s2) are equal to each other.

10. The multiple wiring board according to claim 9, wherein the ratio between said first diameter (r1) and said first interval (s1) is n to 1.
